(19) United States
(12) Patent Application Publication
(10) Pub. No.: US 2014/0281208 A1
(43) Pub. Date: Sep. 18, 2014

(54) Associative Look-up Instruction for a Processor Instruction Set Architecture

(71) Applicant: SILICON GRAPHICS INTERNATIONAL CORP., Fremont, CA (US)

(72) Inventor: Eric C. Fromm, Eau Claire, WI (US)

(73) Assignee: SILICON GRAPHICS INTERNATIONAL CORP., Fremont, CA (US)

(21) Appl. No.: 13/802,086

(22) Filed: Mar. 13, 2013

(51) Int. Cl. G06F 17/30

(52) U.S. Cl. CPC G06F 17/30982
USPC 711/108

(57) ABSTRACT

An associative look-up instruction for an instruction set architecture (ISA) of a processor and methods for use of an associative look-up instruction. The associative look-up instruction of the ISA specifies one or more fields within a data unit that are used as a pattern of bits for identifying data content in a memory structure to be loaded into hardware registers or other storage components of the ISA. Specified parameters of the associative operation may be explicit within the instruction or indirectly pointed to via hardware registers or other storage components of the ISA. The memory structure may be content addressable memory (CAM).

### FIELD OF THE INVENTION

The invention generally relates to processor instruction set architectures for use with processors and, more particularly, the invention relates to an associative look-up instruction for a processor instruction set architecture for use with processors.

### BACKGROUND OF THE INVENTION

A microprocessor is generally an integrated circuit that performs functions based upon received data and according to an instruction set that is stored in memory. A microprocessor will generally include at least a control unit, an arithmetic logic unit, a register array and a system bus. The arithmetic logic unit performs the basic arithmetic and logical operations. The control unit extracts instructions from memory and decodes and executes the instruction calls on the arithmetic logic unit or data storage location, such as registers inside of the microprocessor or memory external to the microprocessor. When used in a computer system, the microprocessor or processor is often referred to as the central processing unit (CPU). The instruction set of a microprocessor or CPU and the various structures that are accessed by those instructions (and thus visible to the software programmer) are together generally referred to as an instruction set architecture. The instruction set architecture includes the instructions that can be issued to the processor and this instruction set serves as the boundary between hardware and software. In general, the instruction set is a set of predefined machine operations and for convenience, a textual assembly language encoding for each instruction is provided which is subsequently converted into an equivalent numerical machine language code. A machine language instruction taken for execution from the instruction set of a CPU is decoded by the control unit of the CPU into implementation specific control sequences. Thus, many CPU implementations may share the same instruction set architecture, but may implement the instructions using different underlying circuitry.

An instruction typically has two parts: an opcode and one or more operands. The opcode identifies what operation should be performed and the operand(s) indicate where the data required for the operation can be found and how to access the data. The exact format of the machine code may be implementation specific. The control unit decodes the instruction, determines the operand, allocates resources (ALU etc.), retrieves required data, and places the resulting data into memory (e.g., internal registers, main memory, or other data storage structures).

Microprocessors execute a sequence of stored instructions known as a program.

In the design of software programs for execution by microprocessors, software designers use hash tables, indexed loop-up tables and other software structures to help reduce the number of value matches required to identify the location of desired data. Such software structures can consume significant memory and still require the execution of many processor instructions to obtain the desired information.

### SUMMARY OF VARIOUS EMBODIMENTS

In accordance with one aspect of the invention, a processor, such as a microprocessor or CPU (“central processing unit”) is disclosed that has a predefined instruction set including an associative look-up instruction. The processor includes a set of registers and a control unit for receiving an associative look-up instruction that is part of the predefined instruction set. The associative look-up instruction causes the control unit to send a control sequence to identify a pattern of bits within a content addressable memory and causes data associated with the pattern of bits to be loaded into one or more of the set of registers. The processor may further include a content addressable memory.

It should be recognized that when the following text references a processor or microprocessor, the processor or microprocessor forms a single structure and corresponds to computer architecture elements that decode compiled and assembled computer instructions and transmits machine code. Thus, a microprocessor that includes a content addressable memory would preferably be formed on a single silicon chip. In other embodiments of the invention, the microprocessor may reference a content addressable memory that is not part of the microprocessor structure and therefore, the microprocessor would communicate off-chip.

The content addressable memory associated with the microprocessor includes a plurality of memory elements and logic for matching the pattern of bits identified in the associative look-up instruction. The control unit of the processor is configured to receive and decode associative look-up instructions. The associative look-up instructions include a bit pattern for matching and may include a mask value and also a destination memory location. The destination memory location may be one or more registers. Each memory element of the content addressable memory includes dedicated matching logic. Each memory element may also include dedicated masking logic. Embodiments of the invention may combine the pattern matching logic and the masking logic into a single logic circuit. As such, a single instruction may, in one clock cycle, compare all of the data within the content addressable memory to the bit pattern and mask and return any matching data.

The associative look-up instruction may be used in the following manner. A control unit of a microprocessor receives a machine language associative look-up instruction at a data input of the microprocessor. In one embodiment, the associative look-up instruction is received in response to a fetch command. After receiving the associative look-up instruction, the control unit generates control signal sequences that are then sent over a control bus to a memory structure. The instruction includes a bit pattern for identifying one or more of the memory elements within the memory structure as containing the bit pattern. When a memory element is matched with the bit pattern, data associated with the memory element is transferred from the memory element to another storage location, such as a register for further processing. The data that is returned may be all or part of the data within the identified memory element.

The returned data may be stored in either a register or other predefined memory location associated with the associative look-up instruction or the associative look-up instruction itself may contain a specified address for storing the identified data. The data may be stored in an instruction set architecture designated storage element. In embodiments of the invention, the control signals resulting from the decoded instruction will identify a mask value or bit field identifier and also a bit pattern or value for matching. The associative look-up instruction, which may be in assembly code, may include a field for identifying the pre-defined data pattern along with a field for identifying the mask. As should be recognized, the mask identifies the bit numbers that will be compared. For example, a mask for a 16 bit data word may indicate that bits 0, 1, 2 and 3 are to be compared to the bit pattern or that bits 0, 3, 6, 9, and 12 are to be compared to the bit pattern.

In certain embodiments of the invention if two or more memory elements are identified as having the predefined data pattern, the microprocessor may include a selection criterion for determining, which memory element should be retrieved and stored in a register. The microprocessor may also trap data and place the data in registers for debugging purposes or exception handling.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of

Illustrative Embodiments,” discussed with reference to the drawings summarized immediately below.

FIG. 1 schematically shows the architecture of software and hardware including a microprocessor, such as a CPU that implements an associative look-up instruction;

FIG. 1A is an exemplary content addressable memory structure with mask and pattern matching logic called out;

FIG. 2 shows an exemplary microprocessor that includes content addressable memory;

FIG. 3 shows an exemplary content addressable memory including pattern matching logic along with examples of patterns and masks that may be employed by the microprocessor; and

FIG. 4 shows a flow chart for operation of an associative look-up instruction with a microprocessor having a content addressable memory.

### DESCRIPTION OF ILLUSTRATIVE EMBODIMENTS

In illustrative embodiments, the invention teaches an associative look-up instruction for an instruction set architecture (ISA) of a processor and methods for use of an associative look-up instruction. The instruction set architecture is understood by the microprocessor where the control unit decodes machine language instructions into control sequences. The associative look-up instruction of the ISA specifies one or more fields within a data unit that are used as a pattern of bits for identifying data content in a tagged memory structure to be loaded into hardware registers or other storage components of the ISA. Specified parameters of the associative operation may be explicit within the instruction or indirectly pointed to via hardware registers or other storage components of the ISA. The tagged memory structure may be content addressable memory (CAM).

An associative look-up instruction and accompanying CAM could be used for accelerated parsing of formatted packets in a communications network. For example, the CAM could be used in conjunction with sparsely encoded fields where an otherwise potentially lengthy serial sequence of value matching comparisons would have to be performed to identify subsequent steps to be taken in processing or routing of a data packet.

FIG. 1 shows a hardware and software hierarchy 100 for execution of a program referred hereinafter as an application 110 using a microprocessor/central processing unit (CPU) 115. The hierarchy includes both software elements including an application-level application 110, a compiler 120, and an operating system 130 and hardware elements including a control unit 140 including a decoder 142 and instruction registers 145, storage registers 150, an arithmetic logic unit 160 and content addressable memory 170. Additionally, the hierarchy includes an instruction set architecture 180 that provides the boundary between the hardware and the software. The instruction set architecture (ISA) 180 includes a number of instructions that may be implemented by a processor. The instruction set architecture describes the type of instructions rather than how the instructions are implemented which can be processor specific. The ISA defines operation that can be applied to architecturally visible features such as registers, memory spaces, and related access attributes. Thus, the underlying hardware that performs the function of an ISA can be implemented in different ways by different processor circuitry.

Typical ISAs include stack, accumulator, and general purpose registers. In the general purpose register type, each operand is associated with an internal memory location such as a storage register 150 within the microprocessor. Thus, these operands can be quickly accessed and implemented.

Embodiments of the invention add one or more instructions to an ISA that allow for associative look-ups in a memory. The memory may be a content addressable memory. As should be understood by one of ordinary skill in the art, an instruction may be composed of a function plus one or more objects (either implied or implicit). The instruction is typically mapped to a textual assembly code representation that is decoded/mapped to a numerical encoding which is machine code.

Content-addressable memory (CAM) is computer memory used for high speed search, data translation, and message parsing applications. Unlike standard computer memory which is accessed by a memory address and the computer memory returns the data stored at the address location, a CAM is designed such that a bit pattern and/or mask is provided and the CAM searches its memory to see if that bit pattern is stored within the memory at the designated mask bit or field locations. If the bit pattern is found, the CAM returns either all of the data within the matched memory element or an associative portion of the data within the memory element that contained the identified bit pattern. Thus, in addition to memory elements, each data line of a CAM may include both masking and pattern matching logic.

The control unit 140 of the microprocessor fetches as input the opcode and operand from memory and places the instruction into an instruction register 145. The opcode and operand are the result of an application being compiled and assembled. The application code is compiled and assembled into machine language and the machine language code is fed into the instruction registers instruction by instruction. The control unit 140 uses a decoder 142 to decode an instruction into a control signaling sequence. Thus, the control unit 140 decodes the machine language and also accesses requested data either in associated registers, cache, random access memory, or content addressable memory. The control unit 140 also accesses and provides the data to the appropriate data processing units such as an ALU, FPU (floating point unit) or content addressable memory. The control unit 140 also provides control signals to processing blocks within the microprocessor (e.g., an arithmetic logic unit, a floating point unit), and writes resulting data back to the registers or other memory.

In certain embodiments of the invention, the CAM may be a mapped region of the main memory address space and may not be part of the microprocessor internal structure. However, such embodiments would still employ an associative look-up instruction within the ISA.

In preferred embodiments, the CAM 170 appears as an extension of a conventional register set for the microprocessor 115, however the CAM registers would have special functionality and the microprocessor 115 would be capable of performing the CAM functionality of identifying a mask and a bit pattern and comparing the mask and bit pattern to the registers. The CAM 170 could be filled with data using ISA standard load/store instructions or the CAM 170 may appear either as a separate memory space (or a separate register space) with dedicated separate instructions for read and write. The CAM 170 could also be loaded under control of an external (TO) mechanism invoked either by the processor itself or some other system agent.

FIG. 1A shows an exemplary CAM 182A with the mask and pattern matching logic 184A called out. An instruction 183A is passed to the decoder 185A of the control unit and the instruction is decoded. The operand (data) of the instruction is fetched according to a standard microprocessor execution pipeline 186A. The mask 187A and pattern 188A are passed to the CAM. For each memory element (e.g., 64 bit entry +1 valid bit) within the N-element CAM, the mask and pattern matching logic 184A is included. The left half of FIG. 1A shows an example of the mask and pattern matching logic 184A that is associated with each element of the CAM. As shown, all data elements are assumed to be 64 bits in length plus a single element valid bit. This is provided for exemplary purposes only and the data length can be different in different embodiments and should in no way be considered as a limitation of the invention.

The mask and pattern matching logic 184A takes a data element 189A as input. The mask specification 187A and the data element 189A are bitwise logically ANDed 190A together. Additionally, the mask specification 187A and the bit pattern 188A and also logically ANDed 191A together. The result of these two operations are then logically bitwise compared 192A together. The data valid bit 199A for the data element 189A and the result of the compare gate 192A are logically ANDed 193A together. The result of the wide AND gate 193A is passed as the element result valid 194A. The element result valid 194A is provided to a multiplexor 195A that receives the data element 189A as input and also receives a second input, which, as shown, is a 0 bit. The multiplexor 195A produces an output which is the element data result 196A. As shown, the individual element data results are passed to a N-to 1 by 64 bit OR gate 197A and the element result valid values are passed to an N-to-1 OR gate 198A. The result of OR gate 197A produces the data result (64 bit word) to a predesignated register or other memory location. The result of OR gate 198A provides whether the result is valid. This can be used by the control unit for execution flow control wherein data is either valid or invalid. If the data is invalid an error will occur and error processing will need to take place.

FIG. 2 shows an exemplary microprocessor structure 200 that includes a CAM 210 and is capable of decoding and executing an associative look-up instruction that is part of the ISA. In this microprocessor structure 200, the microprocessor includes a control unit 220 along with an arithmetic logic unit 230, a floating point unit 240 and a set of registers 250. The present microprocessor structure 200 is meant to be exemplary and other components may be part of the microprocessor structure while other components may be omitted from microprocessor structure without limiting the intended scope of the invention.

Each circuit structure within the microprocessor is coupled to both a communication bus 260 and a data bus 270. Thus, the control unit 220 orchestrates the instruction execution cycle including: instruction fetch; instruction decode, operand fetch (locating and obtaining operand data); execute; result store and obtaining the next instruction.

In one embodiment, the associative look-up instruction operates on data words such as 64 bit data words stored within the CAM 210. The CAM 210 is an associative register array. As such, each element within the array includes a single 64-bit word. The word may include both a key, which is the pattern along with data to be extracted. For example, the first four bits may be the designated mask and the associated pattern may be “0110.” Thus, the CAM will perform a search and return either the entire 64-bit word or a portion of the 64-bit words that includes the first four bits 0110.

Each element of the associative register array 210 includes dedicated masking and pattern matching logic for performing the associative look-up. The instruction specifies a mask value and a bit pattern that together forms the tag matching requirement for the look-up operation. The instruction also includes a storage target identifier for the returned data. The associative look-up instruction may point explicitly to the pattern and mask values or may indirectly point to the pattern and mask values through hardware registers. For example, a direct access associative look-up instruction may be of the form:

| Example Mnemonic | Pattern Value | MASK Value |
|---|---|---|
| LUI | 0xF2300000 | 0xFFF00000 |

In this instruction a look-up is requested for the specific pattern and mask values as provided for in the instruction. This instruction does not specify a particular return storage location. As such, one or more registers within the microprocessor would be designated as a default return location and therefore, the requested data would be positioned within this default register. In other embodiments, the instruction could be pointed to via index or address values given within the instruction. For example:

| Example Mnemonic | Pattern Value | MASK Value |
|---|---|---|
| LUR | 2 | 5 |

In this example, the numbers 2 and 5 specify the register file locations 2 and 5 as containing the ‘pattern’ and ‘mask’ values. In another example, the pattern and mask values may be designated with offset values. For example:

| Example Mnemonic | Pattern Value | MASK Value |
|---|---|---|
| LUA | LU_PARAMS + 2 | LU_PARAMS + 3 |

In this example of the associative look-up instruction, a pair of offsets from a memory base address is used to designate the pattern and mask values. Thus, the pattern and mask values are located relative to the base address “LU_PARAMS”.

It should be recognized that a bitwise mask is a special case of a comparison scope specifier that identifies which portion of the CAM data participate in the pattern match. A bitwise match pattern is a special case of a comparison value specifier. Thus, the present invention should not be seen as being limited to a specific format that requires both a pattern and a mask as part of an associative look-up instruction. For example, a contiguous range of bits using a least significant bit postions (LSB) value and a field size value could be provided in a given embodiment. The associative look-up instruction merely requires a mechanism for specifying which bits participate in the comparison or match and a method of specifying the expected value of those bits. It should also be recognized that the expected value may include the possibility of specifying a range of expected values for the bits. For example, a pattern identifier could be replaced by a pair of numbers specifying a range of values that would qualify as a match.

FIG. 3 shows an exemplary content addressable memory structure 300. The content addressable memory structure 300 includes an array of memory storage elements 305. As shown in this example, the memory storage elements 305 are each 16 bits in length. The memory storage elements 305 include bits 0-15. A 16 bit arrangement is for exemplary purposes only and other size arrangements may also be used.

Associated with each memory storage element 305 is a separate mask and pattern matching logic unit 330. The mask and pattern matching logic unit 330 includes logic for receiving as input the mask and pattern and for comparing the memory storage element to the mask and pattern. Such logical structures are known to those of ordinary skill in the art.

As provided in the example the CAM 300 includes N memory storage elements 305 and has a corresponding N mask and pattern matching logic units 330. As shown, there are two exemplary associative look-up instructions being implemented 340, 350. It should be understood that the associative look-up instruction may be provided to each pattern matching logic element and the instruction is performed in parallel on all of the storage memory elements simultaneously for a specified CAM group. A CAM group may be all of the memory elements within the CAM or a portion of the memory elements within the CAM. Each CAM group would have its own identifier. The CAM group identifier may be a field within the associative look-up instruction or may be part of the pattern to be matched.

As shown in FIG. 3, the first associative look-up instruction 340 is being applied to storage element 0. For this storage element, the mask 345 identifies bits 3, 7, 11, 12 and 13 and looks for the pattern 0,1,1,0,0 (347). The pattern matching logic 330 for memory storage element 0 performs a comparison with the mask and pattern with the storage element 305 and finds that there is a match for storage element 0. Thus, the CAM 300 may return all or part of the data within the storage element to a register associated with the associative look-up instruction. It should be recognized that the mask 345, 355 may be any pattern of bits and is not limited to adjacent bits. Typically, no more than one memory storage element will satisfy the mask and bit pattern of the associative look-up instruction. If there are multiple matches, hardware may implement a selection criterion to determine which match should be returned or the hardware may return the result of some combinatorial operation applied to the multiple matching elements or the hardware may trap execution to a specified address. Condition codes or other status may also be set according to the CAM operation result.

In the case of the first associative look-up instruction 340, the instruction causes the CAM to return data bits 0,2,3,4,5,6,8,9,10,14 and 15 for memory element 0, which are the data bits not at a mask location. This data is then stored in a register and may be further processed by the microprocessor in accordance with subsequent instructions that are fetched by the control unit of the microprocessor. In this example, the bit pattern and the stored data are located at separate bit locations.

A second example of an associative look-up instruction 350 is also shown with respect to FIG. 3. The second associative look-up instruction 350 indicates that the mask is bits 0, 1, 2, 3 (355) and that the pattern to match is 0,1,1,1 (357). As shown in FIG. 3, the second associative look-up instruction 350 is matched against memory storage element 1. The mask and pattern matching logic for memory storage element 1 compares the first four bits (0-3) to the pattern and determines that there is no match. Again, it should be recognized that when an associative look-up instruction is executed, the instruction may be applied to all of the memory storage elements within the array simultaneously.

If none of the memory storage elements match the mask and pattern as is the case in the second example, an execution trap may occur or an invalid status bit may be returned to a predetermined storage location/register.

As previously indicated, when a match occurs, the data that is returned may be the entire content of the matching memory storage element or a portion indicated in the mask may be cleared or the returned data may be otherwise patterned or modified according to the detailed semantics of the actual associative look-up instruction.

The present associative look-up instruction allows any or all of a CAM memory storage elements to apply the mask and pattern matching operations on a per instruction basis. Thus, the memory storage elements of the CAM may be logically subdivided into separate CAM groups allowing the same CAM structure to be used for multiple distinctly different associative look-up operations. Typically, some number of bit patterns would be common to all members of a group and could be used as an identifier of a CAM grouping where each group has a different identified encoding.

FIG. 4 shows a flow chart of a method for using an associative look-up instruction that is part of an ISA. An associative look-up instruction is received in response to a fetch command by the control unit of a microprocessor 400. The control unit directs the instruction to an instruction register and accesses the decode logic. The associative look-up instruction is decoded into control signal sequences that can be understood by microprocessor circuit elements that are electrically coupled to the control unit through a control bus and a data bus 410. The control unit issues control signals to a memory structure, such as a content addressable memory 420. The content addressable memory uses mask and pattern matching logic to compare a mask and pattern to data stored in one or more memory elements of a memory structure. Thus, the instruction may be applied to one or more memory elements of a memory array. The mask and pattern masking logic determines if any of the data elements within the array match the mask and pattern. If data is identified as matching the pattern and mask, the data is retrieved from the memory element within the memory structure and is directed to a register or other memory element associated with the associative look-up instruction 430. The data may then be used by an instruction subsequently executed by the microprocessor.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system. The process of FIG. 2 is merely exemplary and it is understood that various alternatives, mathematical equivalents, or derivations thereof fall within the scope of the present invention.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A processor having an instruction set architecture having a predefined instruction set, the processor comprising:
a set of registers; and
a control unit for receiving an associative look-up instruction that is part of the predefined instruction set wherein the associative look-up instruction causes the control unit send control signals to identify a pattern of bits within a content addressable memory and cause data associated with the pattern of bits to be loaded into one or more of the set of registers.

2. The processor according to claim 1, further comprising:
a content addressable memory wherein the content addressable memory includes a plurality of memory elements and includes logic for matching the pattern of bits identified in the associative look-up instruction.

3. The processor according to claim 1, wherein the associative look-up instruction includes a mask value and a bit pattern.

4. The processor according to claim 2, wherein each memory element of the computer addressable memory includes dedicated matching logic.

5. The processor according to claim 4, wherein each memory element of the computer addressable memory includes masking logic.

6. A method for processing an instruction in a microprocessor, wherein the microprocessor includes a control unit:
receiving an associative look-up instruction at a data input of the microprocessor;
causing the control unit to decode the associative look-up instruction into a control signal sequence;
sending the control signals on a control bus to a memory structure to identify one of a plurality of memory elements within the memory structure as having a predefined data pattern; and
retrieving data from the memory element contained within memory structure associated with the predefined data pattern.

7. The method according to claim 6, further comprising storing the data from the memory element contained within the memory structure associated with the predefined data pattern into one or more microprocessor registers identified in the associative look-up instruction.

8. The method according to claim 6, wherein the associative look-up instruction includes a field for identifying the predefined data pattern.

9. The method according to claim 6, wherein the associative look-up instruction includes a field for identifying a subset of data within a data element having the predefined pattern and a field for identifying a microprocessor register or memory location for storing the subset of data.

10. The method according to claim 6, further comprising storing the retrieved data in an instruction set architecture designated storage element.

11. The method according to claim 6, wherein the memory structure is a content addressable memory.

12. The method according to claim 6, wherein each memory element of the memory structure includes pattern matching logic.

13. The method according to claim 12, wherein the pattern matching logic can match patterns within the memory element.

14. The method according to claim 6, wherein each memory element stores a plurality of bits of information.

15. The method according to claim 6, wherein if more than one memory element matches the predefined data pattern, performing a selection criterion for determining from which memory element having data matching the predefined data pattern, data should be retrieved.

16. The method according to claim 6, wherein the retrieved data of the memory element is different from the matched predefined data pattern.

17. A computer program product including a tangible computer readable medium and computer code thereon for processing an instruction a microprocessor control unit, the computer code comprising:
computer code for receiving an associative look-up instruction at a data input of the microprocessor control unit;
computer code for causing the microprocessor control unit to decode the associative look-up instruction into a control signal sequence;
computer code for sending the microprocessor instructions on a control bus to a memory structure to identify one of a plurality of memory elements within the memory structure as having a predefined data pattern; and
computer code for storing the data from the memory element contained within memory structure associated with the predefined data pattern into a register of the microprocessor.

18. The computer program product according to claim 33, wherein the associative look-up instruction includes a field for identifying the predefined data pattern.

19. The computer program product according to claim 34, wherein the associative look-up instruction includes a field for identifying a data mask.

20. The computer program product according to claim 33, wherein the memory structure is a content addressable memory.
